(19) United States
(12) Patent Application Publication
(10) Pub. No.: US 2025/0253445 A1
(43) Pub. Date: Aug. 7, 2025

(54) POWER STORAGE DEVICE

(71) Applicant: TOYOTA JIDOSHA KABUSHIKI KAISHA, Aichi-ken (JP)

(72) Inventors: Satomi YAMAMOTO, Miyoshi-shi (JP); Yuzo MIURA, Toyota-shi (JP); Takashi GOUDA, Toyota-shi (JP); Yusuke KURUMA, Toyota-shi (JP); Hiroaki YAMAMICHI, Takahama-shi (JP); Haruka TSURUTA, Toyota-shi (JP); Yasumasa OGUMA, Nagoya-shi (JP)

(21) Appl. No.: 19/019,285

(22) Filed: Jan. 13, 2025

(30) Foreign Application Priority Data
Feb. 5, 2024 (JP) 2024-015636

(51) Int. Cl. H01M 10/658; H01M 10/613; H01M 10/653; H01M 10/6555; H01M 50/204

(52) U.S. Cl. CPC H01M 10/658; H01M 10/613; H01M 10/653; H01M 10/6555; H01M 50/204

(57) ABSTRACT

A power storage device includes a pair of power storage cells arranged to face each other in a first direction, a cooling member that is in thermal contact with the pair of power storage cells in a second direction and cools the pair of power storage cells, and a heat insulating member arranged between the pair of power storage cells. The cooling member includes a pair of cell contact portions that respectively come into thermal contact with the pair of power storage cells in the second direction, and a coupling portion coupling the pair of cell contact portions to each other. A thermal resistance of the coupling portion is greater than a thermal resistance of each of the pair of cell contact portions.

### CROSS REFERENCE TO RELATED APPLICATIONS

This nonprovisional application is based on Japanese Patent Application No. 2024-015636 filed on Feb. 5, 2024 with the Japan Patent Office, the entire contents of which are hereby incorporated by reference.

### BACKGROUND

### Field

The present disclosure relates to a power storage device.

### Description of the Background Art

Japanese National Patent Publication No. 2022-549926 discloses a battery pack including a pair of battery modules, a pack case that accommodates the pair of battery modules, and a thermal diffusion prevention member interposed between the pair of battery modules. In this battery pack, when one battery module generates heat, the heat is transferred to the pack case via the thermal diffusion prevention member, thus cooling the one battery module.

### SUMMARY

In the battery pack described in Japanese National Patent Publication No. 2022-549926, there is a concern about heat transfer from one of a pair of battery modules to the other.

An object of the present disclosure is to provide a power storage device that can suppress heat transfer from one of a pair of power storage cells to the other.

A power storage device according to one aspect of the present disclosure includes: a pair of power storage cells arranged to face each other in a first direction; a cooling member being in thermal contact with the pair of power storage cells in a second direction orthogonal to the first direction, the cooling member cooling the pair of power storage cells; and a heat insulating member arranged between the pair of power storage cells. The cooling member includes a pair of cell contact portions that respectively come into thermal contact with the pair of power storage cells in the second direction, and a coupling portion that couples the pair of cell contact portions to each other. A thermal resistance of the coupling portion is greater than a thermal resistance of each of the pair of cell contact portions.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a plan view schematically showing a power storage device in one embodiment of the present disclosure.

FIG. 2 is a sectional view taken along the line II-II in FIG. 1.

FIG. 3 is a sectional view showing part of a top wall in a cooling member.

FIG. 4 is a sectional view schematically showing a modification of the cooling member.

FIG. 5 is a sectional view schematically showing a modification of the cooling member.

FIG. 6 is a sectional view schematically showing a modification of the cooling member.

FIG. 7 is a sectional view schematically showing a modification of the cooling member.

FIG. 8 is a sectional view schematically showing a modification of the cooling member.

FIG. 9 is a sectional view schematically showing a modification of the cooling member.

FIG. 10 is a sectional view schematically showing a modification of the cooling member.

FIG. 11 is a sectional view schematically showing a modification of the cooling member.

FIG. 12 is a plan view schematically showing a modification of a thermally conductive member and a heat insulating member.

FIG. 13 is a plan view schematically showing a modification of a thermally conductive member and a heat insulating member.

### DESCRIPTION OF THE PREFERRED EMBODIMENTS

Embodiments of the present disclosure will be described with reference to the drawings. In the drawings referenced below, the same or corresponding portions are denoted by the same reference numerals.

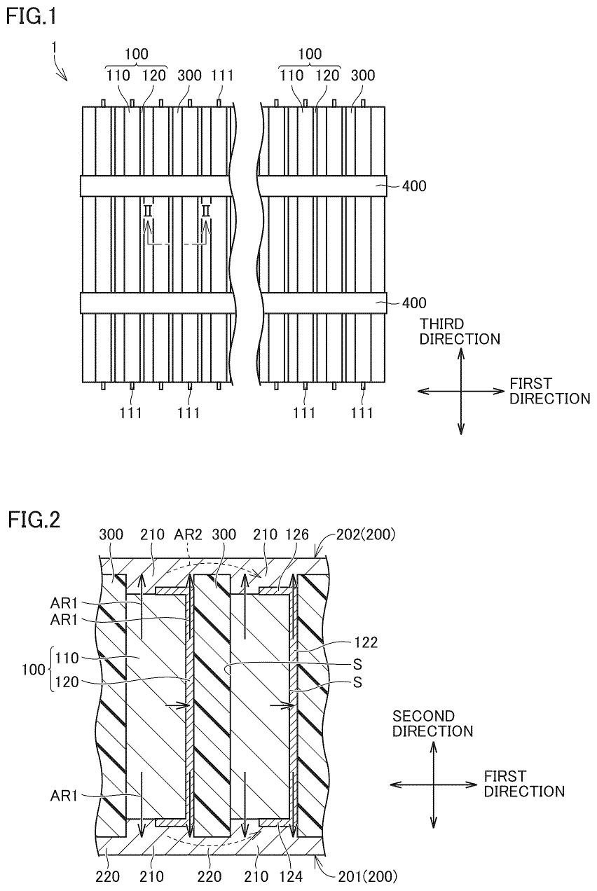

FIG. 1 is a plan view schematically showing a power storage device in one embodiment of the present disclosure. FIG. 2 is a sectional view taken along the line II-II in FIG. 1.

As shown in FIGS. 1 and 2, a power storage device 1 includes a plurality of power storage cells 100, a cooling member 200, a plurality of heat insulating members 300, and a restraint member 400. In FIG. 1, cooling member 200 is not shown.

Power storage cells 100 are arranged side by side in a first direction. Power storage cells 100 include a pair of power storage cells 100 facing each other in the first direction. Each power storage cell 100 includes a cell body 110 and a thermally conductive member 120.

Cell body 110 may be formed of a so-called laminated cell including a laminated exterior package or a so-called square cell including a housing of rectangular parallelepiped shape. Cell body 110 is, for example, a lithium ion battery. Cell body 110 may be formed of an all-solid-state battery including a solid electrolyte. Cell body 110 includes a main surface S (see FIG. 2) orthogonal to the first direction. The dimensions of cell body 110 in a third direction orthogonal to both the first direction and a second direction are greater than the dimensions of cell body 110 in the second direction orthogonal to the first direction. As shown in FIG. 1, cell body 110 includes a pair of external terminals 111. Each external terminal 111 is provided at an end in the third direction.

Thermally conductive member 120 is in thermal contact with cell body 110. Thermally conductive member 120 is made of, for example, metal (such as aluminum). Thermally conductive member 120 includes a base portion 122, a first flange 124, and a second flange 126.

Base portion 122 is in contact with main surface S of cell body 110. Base portion 122 is formed in the shape of a flat plate.

First flange 124 is connected to one end (lower end in the present embodiment) of base portion 122 in the second direction. First flange 124 is orthogonal to base portion 122. First flange 124 may be in contact with cell body 110 in the second direction or be spaced apart from cell body 110 in the second direction.

Second flange 126 is connected to the other end (upper end in the present embodiment) of base portion 122 in the second direction. Second flange 126 is orthogonal to base portion 122. Second flange 126 may be in contact with cell body 110 in the second direction or be spaced apart from cell body 110 in the second direction.

Cooling member 200 (see FIG. 2) cools the pair of power storage cells 100.

Cooling member 200 is in thermal contact with the pair of power storage cells 100 in the second direction. In the present embodiment, cooling member 200 is formed of a case that accommodates power storage cells 100. Alternatively, cooling member 200 may be formed of a heatsink. Cooling member 200 is made of, for example, aluminum.

Cooling member 200 includes a bottom wall 201 supporting power storage cells 100 and a top wall 202 covering power storage cells 100. Bottom wall 201 is in thermal contact with first flange 124. Top wall 202 is in thermal contact with second flange 126.

Heat insulating member 300 is disposed between a pair of power storage cells 100. Heat insulating member 300 is formed in the shape of a flat plate. Heat insulating member 300 is in contact with both the pair of power storage cells 100. Specifically, a side surface of heat insulating member 300 on one side in the first direction is in contact with base portion 122 of thermally conductive member 120 in power storage cell 100 adjacent to the one side of heat insulating member 300 in the first direction. A side surface of heat insulating member 300 on the other side in the first direction is in contact with main surface S of cell body 110 in power storage cell 100 adjacent to the other side of this heat insulating member 300 in the first direction.

Restraint member 400 restrains power storage cells 100 and heat insulating member 300 from opposite sides in the first direction. This maintains contact between power storage cell 100 and heat insulating member 300 adjacent to each other.

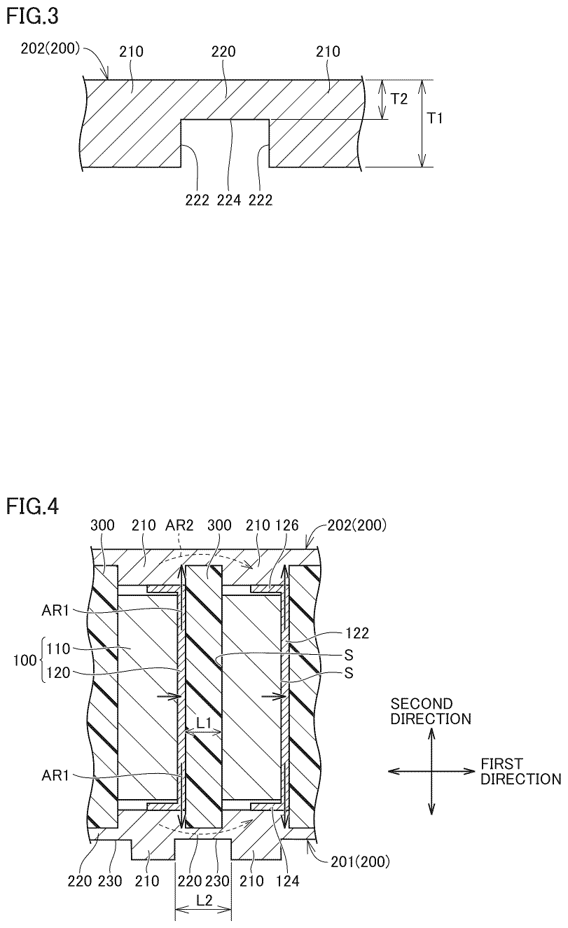

FIG. 3 is a sectional view showing part of top wall 202 in cooling member 200. As shown in FIGS. 2 and 3, cooling member 200 includes a plurality of cell contact portions 210 and a plurality of coupling portions 220.

Each cell contact portion 210 is in thermal contact with its corresponding power storage cell 100 in the second direction. In the present embodiment, cell contact portion 210 is in thermal contact with an end surface of cell body 110 and each flange 124, 126 in the second direction. Alternatively, the end surface of cell body 110 in the second direction may be spaced apart from cell contact portion 210 as long as at least one of flanges 124, 126 is in thermal contact with cell contact portion 210 in the second direction. A thermally conductive material may be provided between each power storage cell 100 and cell contact portion 210.

Each coupling portion 220 couples a pair of cell contact portions 210 adjacent to each other in the first direction. Coupling portion 220 is in contact with heat insulating member 300 in the second direction. The thermal resistance of coupling portion 220 is greater than that of cell contact portion 210. In the present embodiment, as shown in FIGS. 2 and 3, a length T2 of coupling portion 220 in the second direction is smaller than a length T1 of cell contact portion 210 in the second direction. In more detail, the cross-sectional area of coupling portion 220 is smaller than the cross-sectional area of cell contact portion 210. The thermal resistance of coupling portion 220 may be uniform in the third direction.

As shown in FIG. 3, coupling portion 220 includes a pair of clamping portions 222 and a facing portion 224.

The pair of clamping portions 222 clamp heat insulating member 300 from opposite sides in the first direction. Specifically, the pair of clamping portions 222 clamp the end of heat insulating member 300 in the second direction.

Facing portion 224 faces the end surface of heat insulating member 300 in the second direction. In the present embodiment, facing portion 224 is in contact with heat insulating member 300 in the second direction. Alternatively, facing portion 224 may be spaced apart from heat insulating member 300 in the second direction.

As described above, in power storage device 1 in the present embodiment, when one of a pair of adjacent power storage cells 100 generates heat, the heat is transferred to cell contact portion 210 that is in contact with this power storage cell 100, as indicated by the solid arrow AR1 in FIG. 2, but the thermal resistance of coupling portion 220 is greater than the thermal resistance of cell contact portion 210, thus suppressing transfer of the heat from this cell contact portion 210 to cell contact portion 210 adjacent to this cell contact portion 210 via coupling portion 220, as indicated by the dashed arrow AR2. Thus, heat transfer from one of the pair of power storage cells 100 (heat-generating power storage cell 100) to the other (power storage cell 100 adjacent to heat-generating power storage cell 100) is suppressed.

Modifications in the above embodiment will be described below.

### First Modification

As shown in FIG. 4, cooling member 200 may have a recess 230. Recess 230 is formed in an outer surface of cooling member 200 in the second direction. Recess 230 is formed at a position at which recess 230 overlaps heat insulating member 300 in the second direction, and has such a depressed shape as to project inwardly in the second direction. A length L2 of recess 230 in the first direction is greater than a length L1 of heat insulating member 300 in the first direction.

In this example, the end surface of cell body 110 in the second direction is spaced apart from cell contact portion 210. This is true for the above embodiment.

### Second Modification

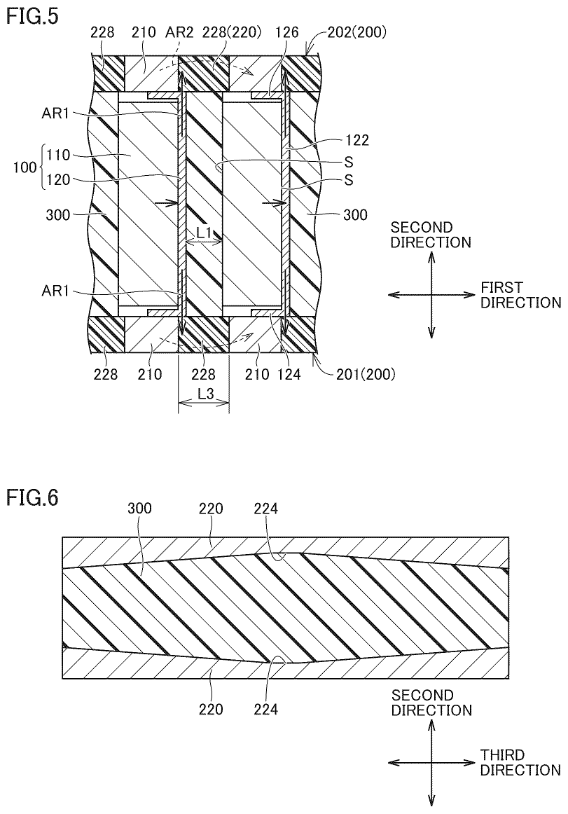

As shown in FIG. 5, coupling portion 220 may have an interposed member 228. Interposed member 228 is interposed between the pair of cell contact portions 210. Interposed member 228 is made of a material (such as a synthetic resin) having a thermal resistance greater than the thermal resistance of cell contact portion 210.

A length L3 of interposed member 228 in the first direction is greater than length L1 of heat insulating member 300 in the first direction. The length of interposed member 228 in the second direction may be equal to the length of cell contact portion 210 in the second direction, or may be smaller than the length of cell contact portion 210 in the second direction.

### Third Modification

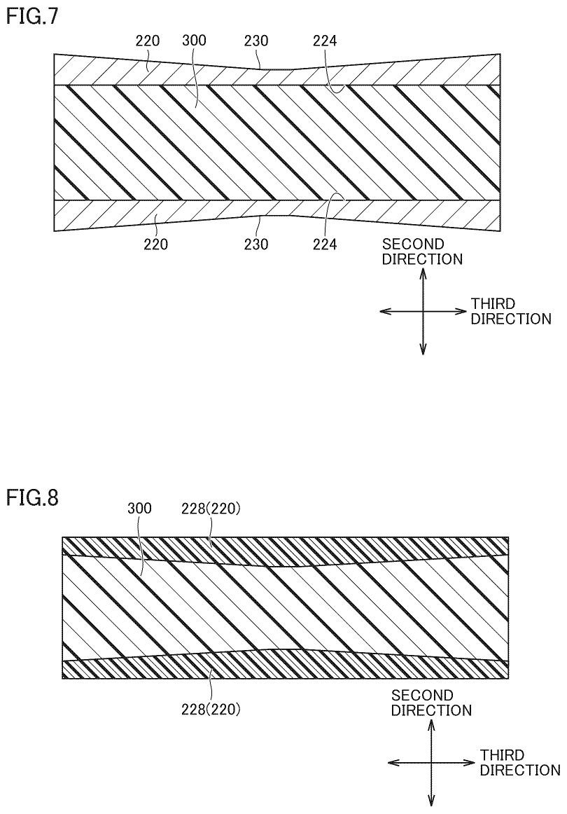

The thermal resistance of coupling portion 220 may gradually decrease outwardly from the middle portion in the third direction. For example, as shown in FIG. 6, the length of coupling portion 220 in the second direction may gradually increase outwardly from the middle portion in the third direction. Alternatively, as shown in FIG. 7, the length of recess 230 in the second direction may gradually decrease outwardly from the middle portion in the third direction. Alternatively, as shown in FIG. 8, the length of interposed member 228 in the second direction may gradually decrease outwardly from the middle portion in the third direction.

### Fourth Modification

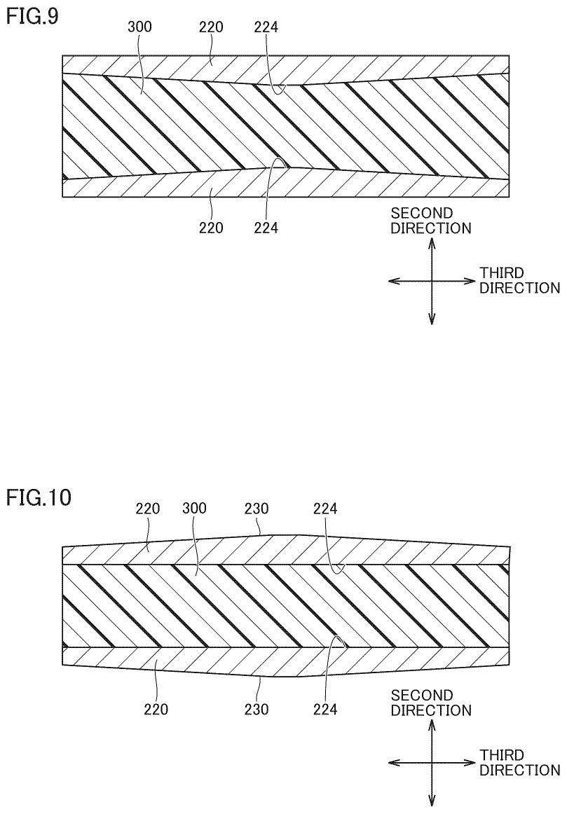

The thermal resistance of coupling portion 220 may gradually increase outwardly from the middle portion in the third direction. For example, as shown in FIG. 9, the length of coupling portion 220 in the second direction may gradually decrease outwardly in the third direction. Alternatively, as shown in FIG. 10, the length of recess 230 in the second direction may gradually increase outwardly in the third direction. Alternatively, as shown in FIG. 11, the length of interposed member 228 in the second direction may gradually increase outwardly in the third direction.

### Fifth Modification

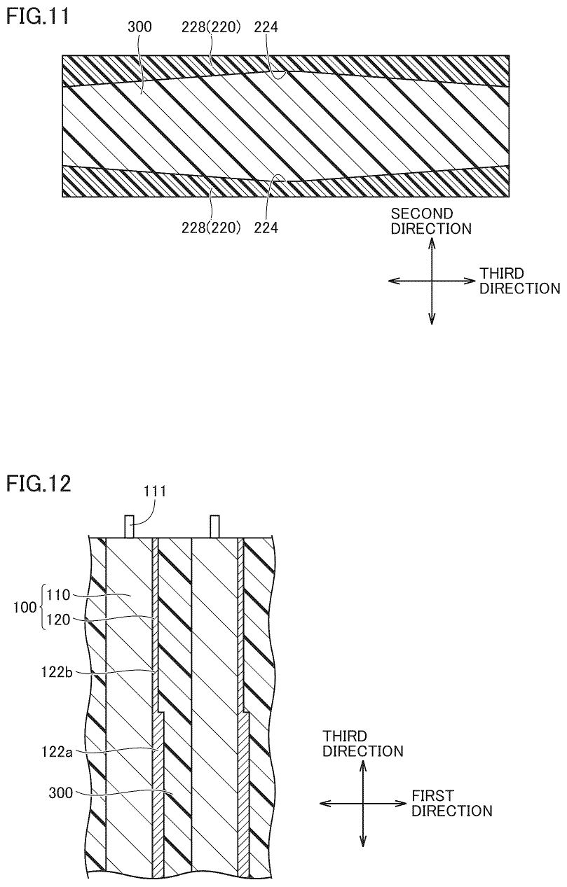

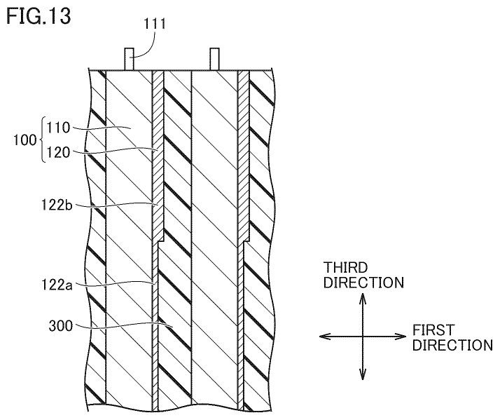

The length (thickness) of base portion 122 of thermally conductive member 120 in the first direction may be formed such that a middle portion 122a in the third direction is formed to be larger than an end portion 122b, as shown in FIG. 12, or end portion 122b may be formed to be larger than middle portion 122a in the third direction, as shown in FIG. 13. In either case, a difference in thickness of base portion 122 of thermally conductive member 120 in the third direction is accommodated by the thickness of heat insulating member 300 in the first direction.

It will be appreciated by a person skilled in the art that the exemplary embodiments and examples described above are specific examples of the following aspects.

### Aspect 1

A power storage device including:
a pair of power storage cells arranged to face each other in a first direction;
a cooling member being in thermal contact with the pair of power storage cells in a second direction orthogonal to the first direction, the cooling member cooling the pair of power storage cells; and
a heat insulating member arranged between the pair of power storage cells, wherein
the cooling member includes
   a pair of cell contact portions that respectively come into thermal contact with the pair of power storage cells in the second direction, and
   a coupling portion that couples the pair of cell contact portions to each other, and
a thermal resistance of the coupling portion is greater than a thermal resistance of each of the pair of cell contact portions.

In this power storage device, the thermal resistance of the coupling portion is greater than the thermal resistance of the cell contact portion. This suppresses, when one of the pair of power storage cells generates heat, transfer of the heat to the other of the pair of power storage cells via the coupling portion and the cell contact portion after transfer to the cell contact portion that is in contact with the heat-generating power storage cell.

### Aspect 2

The power storage device according to aspect 1, wherein a length of the coupling portion in the second direction is smaller than a length of each of the pair of cell contact portions in the second direction.

### Aspect 3

The power storage device according to aspect 2, wherein the coupling portion includes a clamping portion that clamps the heat insulating member from opposite sides in the first direction.

In this aspect, misalignment of the heat insulating member with the cooling member in the first direction is suppressed.

### Aspect 4

The power storage device according to aspect 2 or 3, wherein the cooling member includes a recess formed at a position at which the recess overlaps the heat insulating member in the second direction, the recess being shaped to project inwardly in the second direction.

In this aspect, heat transfer from one cell contact portion to the other cell contact portion is suppressed further.

### Aspect 5

The power storage device according to aspect 4, wherein a length of the recess in the first direction is greater than a length of the heat insulating member in the first direction.

In this aspect, misalignment is suppressed that occurs between the heat insulating member and the recess in the second direction when a tolerance of the power storage cell or the like in the first direction occurs.

### Aspect 6

The power storage device according to any one of aspects 1 to 5, wherein the coupling portion includes an interposed member made of a material having a thermal resistance greater than the thermal resistance of each of the pair of cell contact portions, the interposed member being interposed between the pair of cell contact portions.

In this aspect, heat transfer from one cell contact portion to the other cell contact portion is suppressed further.

### Aspect 7

The power storage device according to aspect 6, wherein a length of the interposed member in the first direction is greater than a length of the heat insulating member in the first direction.

In this aspect, misalignment is suppressed that occurs between the heat insulating member and the interposed member in the second direction when a tolerance of the power storage cell or the like in the first direction occurs.

### Aspect 8

The power storage device according to any one of aspects 1 to 7, wherein a thermal resistance of the coupling portion gradually decreases outwardly from a middle portion in a third direction orthogonal to both the first direction and the second direction.

In this aspect, heat transfer is suppressed from the middle portion of the power storage cell in the third direction to its adjacent power storage cell via the cell contact portion and the coupling portion.

### Aspect 9

The power storage device according to any one of aspects 1 to 7, wherein
each of the pair of power storage cells includes a pair of external terminals respectively provided at ends in a third direction orthogonal to both the first direction and the second direction, and
the thermal resistance of the coupling portion gradually increases outwardly from a middle portion in the third direction.

In this aspect, heat transfer is suppressed from the vicinity of the external terminal, which tends to have a relatively high temperature in the power storage cell, to its adjacent power storage cell via the cell contact portion and the coupling portion.

### Aspect 10

The power storage device according to any one of aspects 1 to 9, wherein the cooling member is formed of a case that houses the pair of power storage cells and the heat insulating member.

### Aspect 11

The power storage device according to any one of aspects 1 to 9, wherein the cooling member is formed of a heatsink.

### Aspect 12

The power storage device according to any one of aspects 1 to 11, wherein
each of the pair of power storage cells includes
   a cell body, and
   a thermally conductive member that comes into thermal contact with the cell body, and
the cell body and the thermally conductive member are in thermal contact with the pair of cell contact portions.

### Aspect 13

The power storage device according to any one of aspects 1 to 11, wherein
each of the pair of power storage cells includes
   a cell body, and
   a thermally conductive member that comes into thermal contact with the cell body,
the cell body is spaced apart from the cooling member, and
the thermally conductive member is in thermal contact with the pair of cell contact portions.

Although the embodiments of the present disclosure have been described, it should be understood that the embodiments disclosed herein are illustrative and non-restrictive in every respect. The scope of the present disclosure is defined by the terms of the claims and is intended to include any modifications within the scope and meaning equivalent to the terms of the claims.

What is claimed is:

1. A power storage device comprising:
a pair of power storage cells arranged to face each other in a first direction;
a cooling member being in thermal contact with the pair of power storage cells in a second direction orthogonal to the first direction, the cooling member cooling the pair of power storage cells; and
a heat insulating member arranged between the pair of power storage cells, wherein
the cooling member includes
a pair of cell contact portions that respectively come into thermal contact with the pair of power storage cells in the second direction, and
a coupling portion that couples the pair of cell contact portions to each other, and
a thermal resistance of the coupling portion is greater than a thermal resistance of each of the pair of cell contact portions.

2. The power storage device according to claim 1, wherein a length of the coupling portion in the second direction is smaller than a length of each of the pair of cell contact portions in the second direction.

3. The power storage device according to claim 2, wherein the coupling portion includes a clamping portion that clamps the heat insulating member from opposite sides in the first direction.

4. The power storage device according to claim 2, wherein the cooling member includes a recess formed at a position at which the recess overlaps the heat insulating member in the second direction, the recess being shaped to project inwardly in the second direction.

5. The power storage device according to claim 4, wherein a length of the recess in the first direction is greater than a length of the heat insulating member in the first direction.

6. The power storage device according to claim 1, wherein the coupling portion includes an interposed member made of a material having a thermal resistance greater than the thermal resistance of each of the pair of cell contact portions, the interposed member being interposed between the pair of cell contact portions.

7. The power storage device according to claim 6, wherein a length of the interposed member in the first direction is greater than a length of the heat insulating member in the first direction.

8. The power storage device according to claim 1, wherein a thermal resistance of the coupling portion gradually decreases outwardly from a middle portion in a third direction orthogonal to both the first direction and the second direction.

9. The power storage device according to claim 1, wherein
each of the pair of power storage cells includes a pair of external terminals respectively provided at ends in a third direction orthogonal to both the first direction and the second direction, and
the thermal resistance of the coupling portion gradually increases outwardly from a middle portion in the third direction.

10. The power storage device according to claim 1, wherein
each of the pair of power storage cells includes
a cell body, and
a thermally conductive member that comes into thermal contact with the cell body,
the cell body is spaced apart from the cooling member, and
the thermally conductive member is in thermal contact with the pair of cell contact portions.

11. The power storage device according to claim 1, wherein the cooling member is formed of a heatsink.

12. The power storage device according to claim 1, wherein
each of the pair of power storage cells includes
a cell body, and
a thermally conductive member that comes into thermal contact with the cell body, and
the cell body and the thermally conductive member are in thermal contact with the pair of cell contact portions.

13. The power storage device according to claim 1, wherein
each of the pair of power storage cells includes
a cell body, and
a thermally conductive member that comes into thermal contact with the cell body,
the cell body is spaced apart from the cooling member, and
the thermally conductive member is in thermal contact with the pair of cell contact portions.
